(19) United States
(12) Patent Application Publication
(10) Pub. No.: US 2005/0026596 A1
(43) Pub. Date: Feb. 3, 2005

(54) Location-based AAA system and method in a wireless network

(76) Inventor: Oren Markovitz, Giva'ataim (IL)

Correspondence Address: KATTEN MUCHIN ZAVIS ROSENMAN, 575 MADISON AVENUE, NEW YORK, NY, 10022-2585, US

(21) Appl. No.: 10/844,969

(22) Filed: May 13, 2004

Related U.S. Application Data
(60) Provisional application No. 60/490,433, filed on Jul. 28, 2003.

(51) Int. Cl. H04M 1/68

(52) U.S. Cl. 455/411; 455/456.6

(57) ABSTRACT

The proposed system according to the present invention introduces an innovative location based approach in order to provide authentication, authorization and accounting (triple-A) of clients suited for hotspots, enterprises and home users in the wireless environment. The system provides full protection against key exchange attackers, while accomplishing the basic requirement for zero-configuration for both fixed and mobile hotspot users, openness and transparency to end-to-end services and protocols. Further more, said system provides Internet Service Providers (ISP) and Wireless Broadband Access Providers billing rather than a way for hotspot providers to bill their customers and a current Wireless network location detection technology which enables accurate detection. All the above make the proposed system worthwhile and much more efficient than existing methodologies and a perfect and essential solution for hotspots, Wireless Broadband Access Providers (e.g. Wi-Max) and other enterprise Wireless network.

### BACKGROUND

The present invention relates to the field of Authentication, Authorization and Accounting (triple-A), which are the three basic requirements for any business and enterprise service and in particular to the field of triple-A in the Wireless environment. Wireless technologies are inherently insecure and exposed to tapping, fraud and denial of service attacks, thus making security a fundamental requirement for commercial application and enterprises in addition to the triple-A. Wireless networks advantages over Local Area Networks (LAN's) are ease of deployment and independency of physical infrastructure (other than servers). These unique attributes give way for a new type of service, which is already deployed using hotspots, i.e. the ability to provide public access services in any place with no configuration or restrictions. The services provided by the Wireless network technology require a new set of tools and a new approach.

The Wireless network environment is challenging in that it possesses two main contradicting requirements; on one hand the security threats are much more complex than the ones in the wired environment and on the other hand the openness of the wireless environment is essential for applications such as hotspots that ideally require zero configuration. Wireless network Access Points (AP) are not only installed in corporate environments as a convenient extension to the wired network, but are starting to be deployed in public hot spots such as airports, hotels and Internet cafes as a means for public internet access. Numerous advances have been made in recent years in the Wireless network environment, such advances including new technology which enable broadband service providers to sell wireless access services (e.g. Wi-Max). For example, US Patent Application No. 20020137524 provides a location based method, i.e. identifies, authorizes and accounts zones, but requires per-user configuration. On the other hand, US Patent Application No. 20030169713 is designed using zero configuration like required but it is not location based. The wireless environment requires stronger encryption and authentication than the wired environment. There have been proposed several solutions to overcome the difficulties—the location based filtering (Bluesoft's Aeroscout™ wireless network location system), the 802.1i, 802.1x based solutions (Cisco's wireless network products) that were designed to meet the wireless triple-A unique requirements and the “Smart up” Wireless network Accounting software that allows accounting of utilization periods per connection. Two of the main factors that prevent existing Wireless network technology from providing accurate locations are the difficulty in measuring location for dynamic clients, since client movements increase the error margin of the measurements and inconsistency of radio wave diffusion—for example, when two clients located at distances of 2 and 4 meters (respectively) from the receiving antenna send out a transmission, it does not take the latter twice the time it takes the former to reach the antenna.

It is thus a prime object of the invention to accomplish a basic requirement for zero configuration (demand per user configuration), provide security against sophisticated attacks and provide both Internet Service Providers (ISP) and Wireless Broadband Access Providers billing rather than a way for hotspot providers to bill their customers. It is thus another object of the invention to provide a current Wireless network location detection technology which enables accurate detection.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is an overview of the wireless environment including the client—server configuration in accordance with the present invention.

FIG. 2 is a detailed illustration of the proposed system according to the present invention.

FIG. 3 is a flow chart describing the different events that are handled by the ULAN location algorithm.

### DETAILED DESCRIPTION OF THE PREFERRED EMBODIMENT

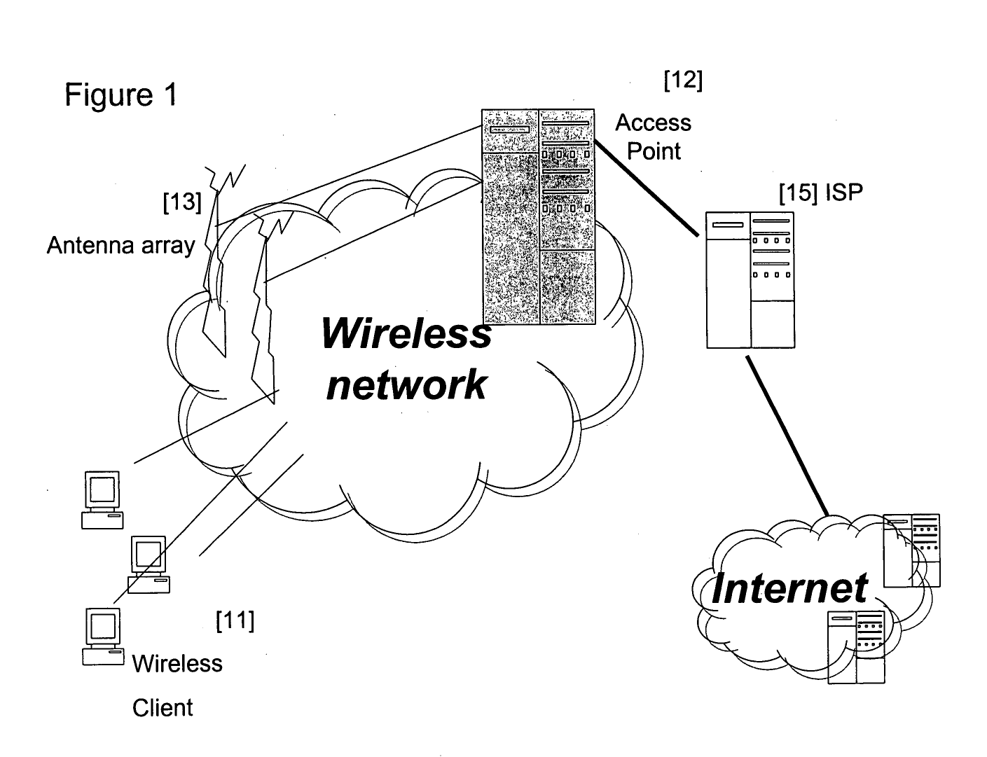

The following configurations shown in FIG. 1 are client-server, however, the present invention can apply for both client-server and server-server configurations. The client-server configuration in the Wireless network environment is transparent to end-to-end services and protocols. The system according to the present invention uses an antenna array [13] to detect the location of the Wireless network client's transmitters and is equipped with one or more Access Points [12], according to the specific Wireless network environment. Said AP is equipped with the proposed system and is responsible for establishing and maintaining secure authenticated sessions with the Wireless network clients [11]. The Internet Service Provider (ISP) as well as the Wireless Broadband Access Providers [15] enable each Wireless network Client accessing the AP a predefined account in order to gain public internet authorization and access [16].

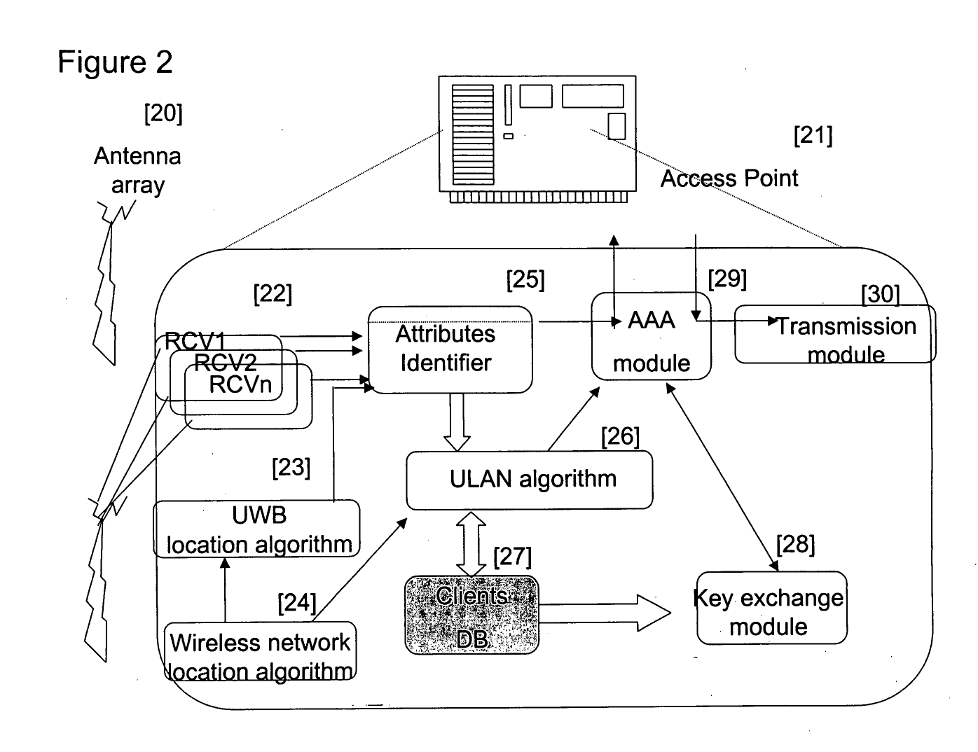

FIG. 2 is an illustration of the Access Point [21], which is comprised of the following components:
Receivers (RCV1 . . . . RCVn) [22], which are network cards, are responsible for receiving the wireless packets and passing the received data along with the MAC and reception related attributes (e.g. time) to the Attributes Identifier module [25].

For achieving wireless communication, the proposed invention uses the Ultra Wide Band (UWB) technology, which is difficult to detect and regulate due to its low power requirements. Said technology, unlike GPS, spans the entire frequency spectrum, thus enabling short range as well as high bandwidth transmissions. Existing UWB chipsets allow detection and placement of objects within a perimeter of 100-200 meters with an error margin of a few centimeters, thus providing radar map of the environment. The proposed UWB technology utilizes an associate UWB location algorithm [23], said algorithm constantly scans the defined perimeter and stores a snapshot of all existing locations and movements of objects within the system range every 10 mSec. The proposed UWB algorithm maintains a database of identified objects accessible through the object's movement pattern; each object contains its exact location and a record of its last 20 movement vectors. The present invention is not limited to the use of UWB technology. Hence, any other location detection technology can be implement for mapping the location the clients.

The Wireless network location detection technology uses an antenna array [20] to detect the location of the Wireless network transmitter. When a client sends a packet it is received on each antenna. Since the antennas are located at different distances from the client, the packet is received at different times on each antenna. Based on these time differences it is possible to compute the location of the sender using well-known triangulation techniques within an error margin of one meter. When a client is activated within the Wireless network premises it is identified by the Wireless network location algorithm [24], which checks the approximate location of each identified Wireless network client by its MAC address every 10 mSec by sending it a “ping” and stores the approximate location and movement differential since the last sample. To increase the accuracy of the system the client's position is computed by comparing it to the set of reference points collected during the learning phase of the system. The reference points represent a database of known distances within the premises. Any client location can be represented as the sum of an “unknown” distance between itself and the closest reference point and the “known” distance between the reference point and the access point (AP). Hence, the proposed system minimizes the error margin of the system by minimizing the “unknown” distance. The Wireless network detection algorithm maintains a database of identified clients; each client record contains the client MAC address, its approximate current location and a record of its last 20 differential movement vectors, which are sampled and then calculated every 10 mSec. The generated database is accessible though the clients MAC address or their movement pattern. The algorithm then scans the database of locations and finds all the reference locations in proximity of one meter or less from the measured client. If no location meets this threshold the closest location is used. The location of the client can be then computed using triangulation calculations. These reference locations are called neighboring locations. The distance of the client to each antenna is then computed using the following formula:
N—Number of neighbors
Tₓ—The time differences of neighbor x
D_{X}—The distances of neighbor x T—The time measured for the client (subtracted from the reference antenna time)
D—Distance from the antenna
   D=(T/T₁*D+T/T₂*D₂+. . . +T/T_{N}*D_{N})/N

The Attributes Identifier module (AI) [25] is responsible for executing the Wireless network and the UWB location algorithms. It processes the attributes delivered by the receivers and produces approximate location identifiers that are then associated with the received MAC address and the UWB location database. The Ultra Local Area Network (ULAN) location algorithm [26] computes the exact location of each Wireless client using the Wireless network and UWB databases and is responsible for updating valid Clients DB [27] and the client's status. This algorithm tries to match a UWB object with each Wireless client by using the movement vectors as an indexing key discovered by the UWB radar—when two patterns match, the exact location of the client can be associated with its MAC address. During the learning phase of the ULAN algorithm, known static locations (of clients with zero movement vectors) require no further computation and the Wireless network location is passed as the accurate location. The ULAN algorithm effectiveness increases in case of dynamic clients. For each received packet, the approximate location of the client is calculated by the Wireless network location algorithm and enhanced based on the stored reference locations, which is passed to the ULAN location algorithm. The algorithm scans the UWB database for locations neighboring to the client approximate location and comes up with a set of candidate locations. The candidate locations movement vectors are compared against the vector provided by the Wireless database and the candidate most similar in vector and location is identified as the accurate location of the client. In addition to this, the ULAN algorithm is responsible for identifying new clients, assigning them virtual identifications (IDs) and updating the virtual ID location. The virtual ID, which is assigned to Wireless network clients, is composed of the client MAC address and its accurate location coordination's. Although the proposed location algorithm is complimented using the radar technology, such technology is complementary.

The Clients Database (DB) [27] stores the authenticated wireless clients, their status, accounting information and other attributes.

The Key Exchange module [28] initiates and handles a Diffie Hellman (DH) key exchange sessions with the authenticated clients. The DH key exchange is immune to man-in-the-middle and denial of service attacks, which follows the standard DH algorithm used in Internet Key Exchange (IKE) and similar key exchange protocols. The generated keys are stored in the Clients DB and refreshed by the key exchange module upon a configurable time out.

The AAA module (Authentication, Authorization and Accounting) [29] implements both rule definition and enforcement. Incoming traffic is first examined by the Attributes Identifier module (AI) and ULAN algorithm, which compute the exact location of the source. The incoming packet along with the location of the source is then passed to the triple-A module that filters the packet (drop/pass) according to the pre-defined rules and associates the location of the sender with a pre-defined billing zone.

Legal packets being further processed from the Triple-A module are passed to the Transmission module [30] that transmits the packets to the Internet Protocol (IP) stack.

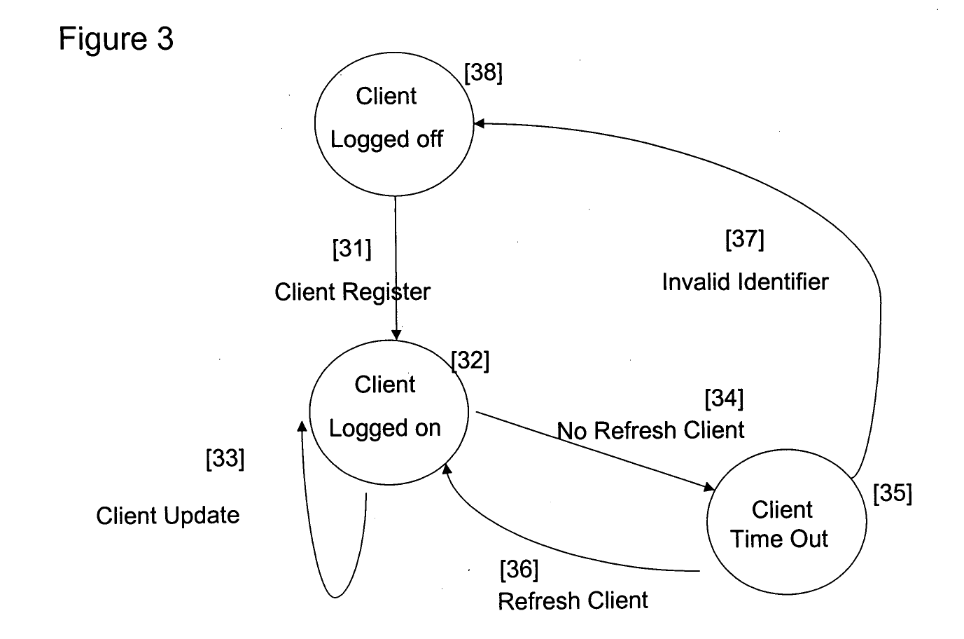

FIG. 3 is a flow chart, illustrating the states for each wireless client and describes the different events that are handled by the ULAN location algorithm according to the present invention;
Client log on [32]—Upon receiving a packet from an un-registered client, the client MAC address along with its reception identifiers are registered [31] in the database. Once a client is registered in the database the algorithm will continuously update [33] its reception identifiers upon each received packet.
Client time out [35]—A client record is considered timed out if it hasn't been refreshed by a received packet [34] for a configurable period of time. The algorithm will try to refresh [36] the client record by polling it.
Client log off [38]—A client is considered logged off and is erased from the database when the received packet identifiers are considered invalid [37]. In this case, the reception identifiers differ from the stored ones by more than a pre-configured threshold and the packet is dropped.

The proposed system provides an innovative billing and accounting service, defined zone-based billing, which is location rather than user based. Traditional billing and accounting technologies identify, authorize and account users. This system identifies, authorizes, and accounts zones. Location based rules consist of a physical zone premises and an action (e.g. location=the boundaries of an organization, action drop packets originated from a source located outside the defined premises). The target users for this new service are cafe and hotel hotspots operators. These operators typically bill customers by room or table and not by their user ID. Billing zones are defined in a similar way to FireWall (FW) zones.

According to further improvement of the present invention, the proposed system may use a stand alone dedicated component, the “Wireless-Marker” (Wi-Marker), during the learning phase of the ULAN algorithm that can send Wireless network transmissions and accurately compute its own location by using different complementary location detection technologies, e.g. UWB technology. The Wi-Marker is composed of a Wireless network transmitter configured with a pre-shared secret and an UWB location system. The Wi-Marker sends a transmission to the system's antennas when activated, consisting of its accurate location and an identifier allowing the system to compute a “reference point”. A reference point is the location time differential for each client location calculated by comparing the reception time at each antenna. Assuming the system has four antennas, the first antenna is used as the reference antenna and the time difference for each of the other antennas is computed by subtracting its reception time from the reference antenna's reception time. The system accuracy increases as the number of reference points increases. In order to measure time by each antenna, said system takes advantage of the frequency hopping property of 802.1x layer one protocols. According to 802.11 the transmitter changes its carrier frequency every 20 mSec. Each antenna circuit looks for the time at which a carrier frequency change takes place rather than for the reception time. The originating transmitter changes in carrier frequency is received at different time stamps depending on their distance from the transmitter and can therefore be used for calculating the transmitter location as described above. Several techniques are available for detecting this time. One existing techniques is the phase-locked pulse (PLL) circuit, which sends a pulse each time a new lock is established. The proposed system utilizes said pulse as an indicator for frequency change. In order to increase the strength of the received carrier signal the receiving antennas detect the changes in strength at different time periods depending on the distance from the transmitting client. Said strength is detected either in the RF signal, IF signal or in the I and Q levels of the modulated information.

Each zone boundaries (e.g. room or table) are defined using maps of Wi-Markers and are stored in the triple-A module. The triple-A module implements both “billing zone” definition and accounting. Incoming traffic is first examined by the A module and ULAN algorithm that compute the exact location of the source. The incoming packet along with the location of the source is then passed to the triple-A module that associates the location of the sender with a pre-defined billing zone. Legal packets originating from an authorized zone continue the processing path and are passed to the Transmission module that sends the packet to the IP stack. The triple-A module updates the accounting database and alternatively sends the accounting information to external accounting servers.

According to alternative embedment of the present invention is suggested another way for setting the premises definitions by using Graphic User Interface (GUI) maps, which sketches a map of the premises and specifies the location of the antennas within the map. Assuming the user defined less reference points on the premises boundaries, this option is less accurate. Filtering is executed by comparing the sender location with the rule definitions. Consider a case were a client is located just outside of the premises (e.g. 20 cm). Since existing Wireless network location technology has a typical error margin of one meter, such a client might be perceived as legal! One way of insuring accurate filtering is defining enough reference points on the premises boundaries.

Zone based billing is well suited for hotspot providers such as cafes, hotels and Wireless Broadband Access Providers. Hotspots that provide mobile users such as airports or railway stations require a different type of billing and accounting. Therefore, the proposed system also introduces a new billing station, a BandWidth (BW) leasing technology, that is location authorized for airports or railway stations, for example. This process includes two phases; an initial phase, in which the user approaches the billing station and places its computer/Personal Digital Assistant (PDA) in a designated location and a second phase, in which the user uses its credit card to lease BW, while no configuration is required. The billing station locations are fixed and known to the system's servers. When the user's credit card is registered, the system sends a message to the user's Personal Computer (PC) asking it to create a unique ID and send it hashed (in order to prevent tapping) to the AP station. The system associates the received hashed-ID with the user and authenticates the request by comparing the sender location with the station fixed location. The location authentication prevents illegal users from registering at the expense of the legal user. When the user tries to access the hotspot it uses its credentials to authenticate itself. The system identifies the user and allows it to access the Wireless network services. Furthermore, in order to provide multi-zone and multi-hotspots access based on a single BW leasing operation, the system allows multiple AP and hotspots to use the same accounting server.

In Wireless network key exchange protocols typically take place between Wireless network clients and the Access Point (AP). Man-in-the-middle attack relies on the ability of the attacker to impersonate as the AP against the client and vice versa. In order to prevent client impersonation attempts, the AP identifies users by their virtual ID, which is assigned to them by the ULAN algorithm, instead of the original MAC address. The virtual ID is unique to each client and cannot be forged. The system employs several techniques to prevent AP impersonation as well. These techniques do not require special HW or extra configuration on the user side. Key exchange protocols typically include two phases; an initial phase, in which the client sends a packet to the AP and a second phase, in which the AP sends a packet to the client. The AP constantly monitors the Wireless network for AP impersonators. Once detected, this AP pinpoints their physical location and the attacker can then be physically removed from the premises. Location based authentication takes advantage of the system's unique ability to compute the time its message will reach the client. At the first phase, the client adds its own time stamp to the packet. At the second phase, the AP adds an anticipated reception time stamp to the packet. Finally at the last phase, the client authenticates the AP by comparing the time stamp with the actual reception time. Another way of authenticating the AP packet is by resending it to the AP and waiting for a confirmation or denial message. If an impersonator generated the second phase packet, the legal AP will detect it and send a deny message to the client. Since the client will discard the key exchange upon receiving a single deny message, attempts to generate false confirmation packets will fail.

The triple-A module enforces security by encrypting and decrypting packets with clients that support this functionality. Upon receiving an encrypted packet, the appropriate keys are fetched from the client DB and the packet is decrypted, the client's accounting record is updated and the packet is sent on to the IP stack. When the keys do not match the client MAC and parameters the packet is dropped and a security alert is generated.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

### SUMMARY

The present invention security system takes advantage of the physical characteristics of the wireless environment to provide unique physical user authentication resistant to fraud and man-in-the-middle attacks while maintaining zero configuration by the user and IT manager. Immune to man-in-the-middle and denial of service attacks, the system's authentication requires no prior configuration or off-line procedures prior to session establishment while providing an authenticated and location based authorized channel.

The uniqueness of the proposed system over existing technologies lies in its ability to authenticate clients based on an innovative high precision location technology. Furthermore, the system identifies the wireless clients by A set of attributes including their MAC address and other parameters unique to their wireless transmission and location providing zero configuration security, unlike per user configuration requirements in current solutions. These parameters are unique to each user and cannot be forged.

1. a system for providing authentication, authorization and accounting services for Wireless network devices within Wireless network based on devices location, requiring zero configuration, said system comprised of:
an antenna array scattered within the Wireless network;
at least one Access Point for establishing and maintaining secure authenticated sessions with the Wireless network devices, said access point including: at least one receiver, at least one transmitter, a location algorithm scanning location of object within predefined range, a Wireless network algorithm for identifying Wireless network clients and measuring their position in comparison to know reference point based on measured distances from the scattered antennas, ULAN algorithm for matching identified objects with identified Wireless network clients in accordance with their location coordinates, an AAA module based on ULAN identification results and a clients database

2. The system of claim 1 wherein the access point further includes a Key Exchange module for authenticating clients sessions.

3. The system of claim 1 wherein the ULAN algorithm further assigns Wireless network clients with virtual IDs, said virtual ID composed of client MAC address and its location attributes.

4. The system of claim 1 wherein the Wireless network algorithm and location algorithm track the objects and clients movements and maintain vector records of the clients and objects last movements, wherein said movements vectors are further used by the ULAN algorithm for matching between identified objects and Wireless network clients.

5. The system of claim 1 wherein the reference points are determined through learning phase of the system.

6. The system of claim 5 further comprising Wireless Markers for computing the references point through the learning phase of the systems.

7. The system of claim 1 wherein the AAA module implements pre-defined enforcements rules in accordance with ULAN identifications of Wireless network clients locations.

8. The system of claim 7 wherein the AAA module include billing service rules based on Wireless network client location in accordance to predefined billing area zones.

9. The system of claim 8 wherein the AAA module include second phase identification process for registering user credit card by creating a unique credit-ID.

10. The system of claim 1 wherein the location algorithm utilize UWB technology.

11. The system of claim 1 wherein the measured distances from the scattered antennas are achieved by computing the location time differential for each client by subtracting its reception time from the reference antenna's reception time.

12. The system of claim 1 wherein the measured distances from the scattered antennas are achieved by identifying carrier frequency changes.

13. The system of claim 12 wherein the identification of carrier frequency changes antennas utilizes phase-locked pulse (PLL) circuit techniques.

14. A method for providing authentication, authorization and accounting services for Wireless network devices within Wireless network based on devices location, requiring zero configuration utilizing an antenna array scattered within the Wireless network, said method comprised of:
Establishing and maintaining secure authenticated sessions between at least one Access Point and the Wireless network devices
scanning location of objects within predefined range
identifying Wireless network clients and measuring their position in comparison to know reference point based on measured distances from the scattered antennas;
matching identified objects with identified Wireless network clients in accordance with their location coordinates;
providing an authentication, authorization and accounting services based on identification matching results and a clients database

15. The method of claim 14 further comprising the step of authenticating client sessions using Key Exchange technique.

16. The method of claim 14 further comprising the step of assigning Wireless network clients with virtual IDs, said virtual ID composed of client MAC address and its location attributes;

17. The method of claim 14 further comprising the steps of: tracking the objects and clients movements and maintaining vector records of the clients and objects last movements, wherein said movements vectors are further used by the for matching between identified objects and Wireless network clients.

18. The method of claim 14 wherein the reference points are determined through learning phase of the system.

19. The method of claim 18 further comprising the step of computing the references point utilizing Wireless Markers through the learning phase of the systems.

20. The method of claim 14 wherein the authentication, authorization and accounting services implement pre-defined enforcements rules in accordance with identifications and location of Wireless network clients.

21. The method of claim 20 wherein the accounting service include billing service rules based on Wireless network client location in accordance to predefined billing area zones.

22. The method of claim 21 wherein the accounting service further include the step of creating a unique credit-ID for identification of registration of user credit card.

23. The method of claim 14 wherein the location process utilize UWB technology.

24. The method of claim 14 wherein the measurement of distances from the scattered antennas is achieved by computing the location time differential for each client by subtracting its reception time from the reference antenna's reception time.

25. The method of claim 14 wherein the measurement of distances from the scattered antennas is achieved by identifying carrier frequency changes.

26. The method of claim 25 wherein the identification of carrier frequency changes antennas utilizes phase-locked pulse (PLL) circuit techniques.
